(19) United States
(12) Patent Application Publication
(10) Pub. No.: US 2002/0162029 A1
(43) Pub. Date: Oct. 31, 2002

(54) Method and system for broadband network access

(76) Inventors: Keith Joseph Allen, Austin, TX (US); Michael Wayne Russina, Austin, TX (US)

Correspondence Address: BRINKS HOFER GILSON & LIONE, P.O. BOX 10395, Chicago, IL, 60610, US

(21) Appl. No.: 09/843,291

(22) Filed: Apr. 25, 2001

(51) Int. Cl. H04L 9/32

(52) U.S. Cl. 713/202

(57) ABSTRACT

A subscriber authentication service is provided by a network access system. The system includes a remote access server (RAS) having ports for communicating with subscribers, a management interface for associating line identifiers with the subscriber ports, and a database for storing the line identifiers. In response to receiving a subscriber login request on a port, the RAS retrieves a corresponding line identifier from the database and transfers it to a service provider. The service provider can then authorize access to a requested network service based on the line identifier and other subscriber information, such as a user identifier (ID) and password. The line identifier is an additional piece of user information, assigned by the RAS and associated with an end-user device or connection port. The line identifier offers a higher level security to service providers, and can prevent unauthorized access to services by users having stolen user IDs and/or passwords.

### TECHNICAL FIELD OF THE INVENTION

The present invention generally relates networked information systems, and in particular, to a network architecture for authorizing subscriber connections to networked service providers.

### BACKGROUND OF THE INVENTION

Telecom carriers are now deploying networks that enable subscribers to access the Internet and other services such as video-on-demand (VOD) using high-speed (broadband) network access technologies, such as cable networks and digital subscriber lines (DSLs). For competitive and regulatory reasons, many telecom carriers are supporting the capability to enable the subscriber to choose which service provider he/she would like to use for these services. A similar capability is also used to enable employees to work at home by logging in to enterprise networks at broadband speeds.

In the Internet dial-up modem-based world, the equipment in a carrier's network that answers a telephone call from a subscriber's modem and transfers data to the Internet Service Provider's (ISP's) data network is known as a remote access server (RAS). A similar capability exists in broadband networks that enables a subscriber to access the service provider of their choice. The equipment performing this function is referred to as a broadband remote access server (B-RAS).

FIG. 1 shows a prior art broadband access network system 100 that allows subscribers to dynamically choose their service providers. The system 100 includes one or more of subscriber units 102 located at customer premises, a telecommunications carrier 105 having an access multiplexer 104 and a broadband remote access server (B-RAS) 106, a broadband network 108, and service providers 110-112. Each of the service providers 110-112 includes databases 114-116 for storing user (subscriber) information, such as login IDs and passwords.

Each subscriber unit 102 is connected to the access multiplexer 104 with a high-speed access line, such as a DSL or an ADSL line. Subscribers on such a network initiate connections to their chosen information service provider much the same way that dial-up modem users do. A window pops up on their computer screen prompting them for a destination login ID and password. The login ID can be a string with the form <user>@<domain>, for example, “max@prodigy.com”. The computer transmits the login ID and password to the B-RAS 106. The B-RAS 106 checks the domain part of the login ID and matches it against the list of destination service providers to which it has connections. If it has a connection to the requested domain (in this example, prodigy.com) it forwards the login ID and password to the destination for confirmation. The service provider can authenticate the login ID and password using a RADIUS (Remote Authentication Dial In User Service) server 115, 117. If the selected service provider confirms that the login ID and password are valid, a message to this effect is sent to the B-RAS 106, which then establishes a connection between the subscriber and the destination service provider, permitting information to flow between them.

Many ISPs rely on subscriber login identifiers (IDs) and passwords alone to authenticate users. As more services are accessed through broadband networks, it may become increasingly important to deny service to people who attempt unauthorized access using stolen or shared login IDs and passwords. Accordingly, there is a need for a broadband networking system that offers improved access authentication and security.

### BRIEF DESCRIPTION OF THE DRAWINGS

FIG. 1 is a diagram illustrating a prior art broadband access system;

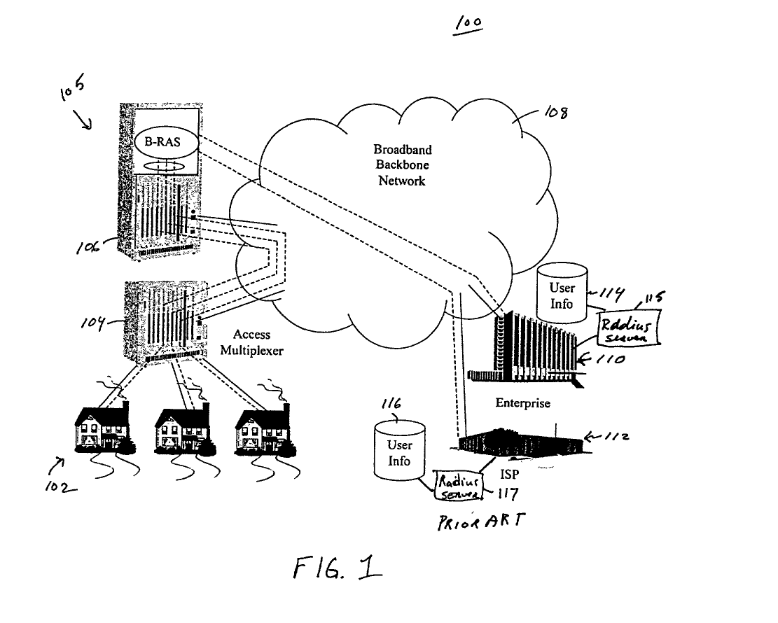

FIG. 2 is a diagram illustrating a broadband access system in accordance with an embodiment of the present invention;

FIG. 3 is a diagram illustrating a broadband access system in accordance with another embodiment of the present invention; and

FIG. 4 is a flow chart illustrating the operation of the systems shown in FIGS. 2-3.

### DETAILED DESCRIPTION OF THE PRESENTLY PREFERRED EMBODIMENTS

It is an advantage of the present invention to provide a line ID service that enables service providers to enforce security measures beyond simple login IDs and passwords. This service provides significant benefits to security-conscious enterprises and service providers, particularly those offering valuable broadband services like video-on-demand.

The line ID service enables a service provider to offer an additional level of security by verifying that the user is accessing the service from a designated location or device. The line ID service can identify the subscriber line or port from which a broadband service access is being initiated. It does this by making available to the service provider a line ID for a subscriber attempting to access the service provider's service. The service provider can match the line ID against its records for security purposes.

Although usable with many types of networks, the line ID service is primarily intended for broadband access networks. In some ways, the line ID service disclosed herein is analogous to telephony Caller-ID service: the carrier delivers to the called party (i.e., service provider) information identifying the calling party (i.e., subscriber). This service is useful in helping the called party to identify the calling party, who might claim to be anyone, and to help them decide if they wish to accept the connection. It also provides an opportunity for the carrier to generate revenues by charging the called party for this added security feature.

Login IDs and passwords can be stolen, then sold or shared with others. The fraudulent use of information services could become a significant problem, especially as the value of the information services increases. One example is pay-per-view movies. A pay-per-view movie provider might be interested in making sure that a subscriber is not using a stolen or borrowed login ID and password. The line ID service can ensure that the user is connecting from a designated location or unit.

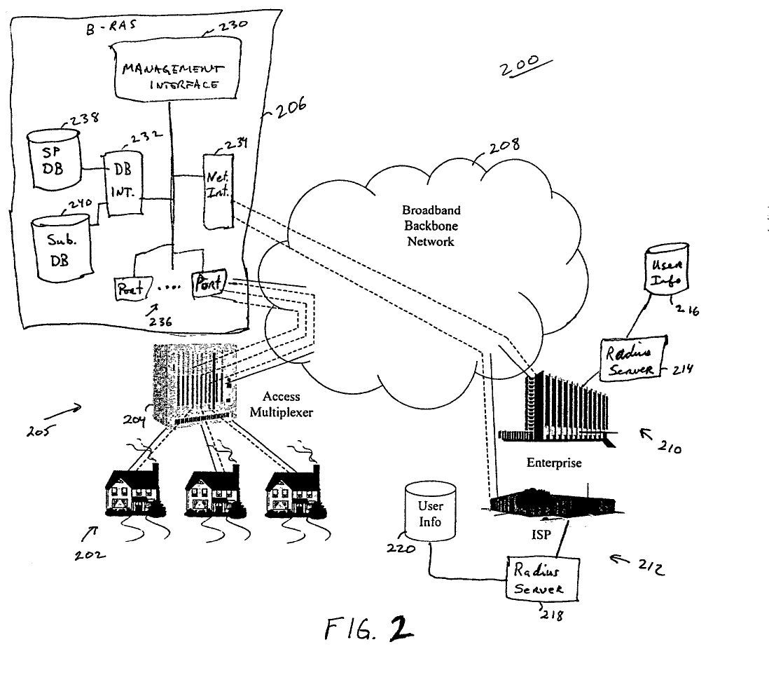

FIG. 2 is a diagram illustrating an exemplary broadband access system 200 in accordance with an embodiment of the present invention. The system 200 includes one or more of subscriber units 202 located at customer premises, a telecommunications carrier 205 having an access multiplexer 204 and a B-RAS 206, a broadband network 208, and service providers 210-212. Each of the service providers 210-212 can include RADIUS servers 214, 218 and user information databases 216, 220.

The B-RAS 206 includes a management interface 230, a database (DB) interface 232, a network interface 234, one or more ports 236, a service provider database (SP DB) 238, and a subscriber database 240. The subscriber units 202 connect to the access multiplexer 204, which then accesses the B-RAS 206 through the backbone network 208.

The B-RAS 206 can be a commercially-available broadband service node (BSN) that is programmed and configured to perform the functions disclosed herein.

The access multiplexer 204 can be a commercially-available digital subscriber line access multiplexer (DSLAM).

The broadband backbone network 208 can be any suitable high-speed computer network for transferring digital information between the carrier 205 and the service providers 210, 212. The network 208 can be the public Internet backbone or a telecommunications data network, such as an asynchronous transfer mode (ATM) network, provided by the carrier 205.

The service providers 210, 212 include networked information service providers offering data services to end users at remote locations, such as the subscriber units 202 at customer premises. The service providers can be enterprise-wide information systems 210, such as corporate intranets, as well as commercial information service providers 212 that offer networked services for a fee, such as ISPs.

The subscriber units 202 include any suitable device capable of connecting to the B-RAS 206 and utilizing the services of one or more of the service providers 210, 212. A subscriber unit can be a personal computer having networking capabilities, a set-top box, a wireless device having a networking interface, such as a lap-top computer, web-enabled cellular phone or pager, or the like.

Each subscriber unit 202 is connected to the access multiplexer 204 with a high-speed access line, such as a DSL or an asymmetrical DSL (ADSL). Accordingly, each subscriber has a permanent logical connection from their residence to the B-RAS 206. Each of the possible service providers 210-212 that the subscriber can access also has a permanent logical connection to the B-RAS 206 over the broadband network 208.

Line identification is accomplished by assigning a carrier-allocated identifier to the physical or logical port on which a subscriber is connected to the B-RAS 206. The line identifier is also shared with the subscriber when service is installed. The network equipment of the carrier 205, not the subscriber, provides the line ID. Thus, the line ID is relatively difficult to fake or steal, improving overall access security.

The format of this identifier can be a character string, and can resemble an account number, telephone number, Internet user ID, or the like. To ensure that IDs allocated by different carriers are unique a standard format can be used. One format is to use an Internet user ID format, such as 123456789@sbc.net.

In order to implement the line ID service, the B-RAS 206 is configured using software code. The B-RAS 206 is programmed to associate a unique line identifier with each subscriber connection when a subscriber's service is first provisioned. The line ID can be a number, alphanumeric string, or text string consisting of a user ID and Internet domain name. The latter would make it easy for a carrier to choose unique values without the need for an additional agency to oversee the administration of them. The line ID can be associated with the subscriber's connections by having a carrier employee or system enter the allocated line identifier onto the management interface 230 of the B-RAS 206 in a set-up message, along with other subscriber-related information (e.g., service speed) when the subscriber's carrier service is initially set up.

The management interface 230 can include a terminal or computer management system connected to the B-RAS 206 providing access to this information.

The B-RAS 206 stores the line ID value assigned to a subscriber connection in the subscriber DB 240. This value is also shared with the subscriber when service is initiated, much the same way a telephone number is shared with a subscriber when telephone service is started.

At the time of provisioning the line ID service to service providers 210, 212, the carrier 205 can offer the line ID service to information service providers 210, 212. Software on the B-RAS 206 allows the carrier 205 to identify which service providers subscribe to the line ID service. The identities of subscribing service providers are stored in the SP DB 238 of the B-RAS 206.

Those providers that are subscribing members to the line ID service can ask their subscribers, which use the carrier 205, for their line IDs when setting up a service provider account for the subscriber. The subscriber can provide the line ID, and can be given a login ID and password by the information service provider. The information service provider can then associate the subscriber's line ID with their login ID and password in the user database 216, 220.

In addition to storing the line IDs and flags indicating which service providers have signed up for the line ID service, the B-RAS 206 also includes software to send the line ID to the destination service providers that have subscribed to the line ID service. One way of accomplishing this is to extend the RADIUS protocol to include the line ID in a new field of the authentication request message. Alternatively, an existing field within the authentication request message can be defined to carry the line ID.

Another alternative is to allow the service provider RADIUS servers 214, 218 to query the B-RAS 206 with subscriber login IDs, and get back the line ID(s) of the line(s) from which the subscriber is currently attempting to login into the service provider.

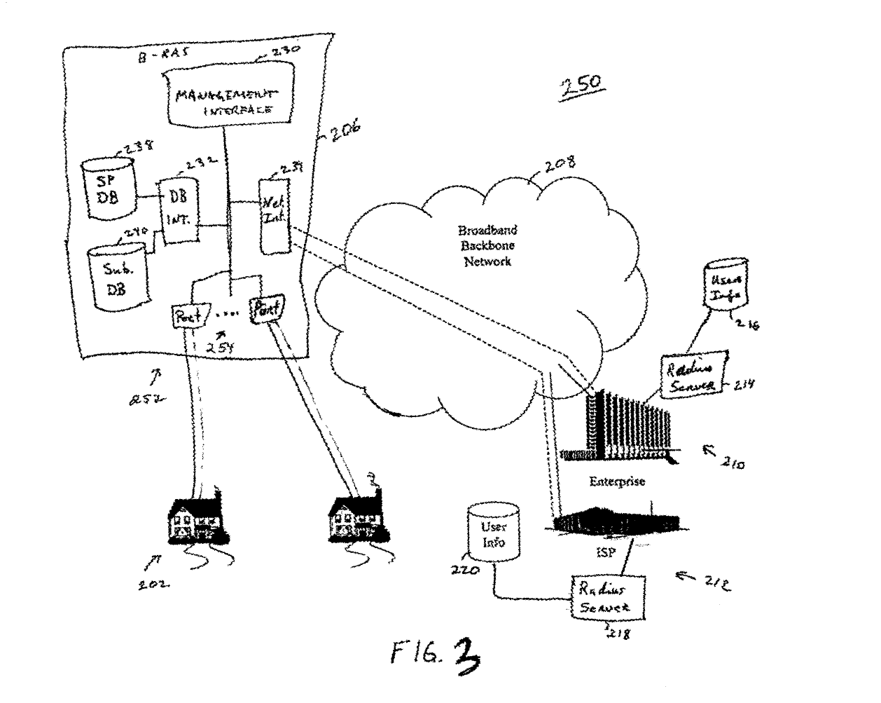

FIG. 3 is a diagram illustrating an exemplary broadband access system 250 in accordance with another embodiment of the present invention. The system 250 includes a telecommunications carrier 252 having a B-RAS 206 that supports direct connections between the subscriber units 202 and the ports 254. This configuration of the B-RAS 206 permits DSL subscribers to access the service providers 210, 212 without having to first connect to the separate access multiplexer 204, as depicted in FIG. 2. In this arrangement, multiplexing services, if any are used, can be incorporated into the B-RAS 206 of the carrier 252.

The network architectures shown in FIGS. 2-3 are exemplary, and alternative architectures, such as those having subscriber and SP databases external to the B-RAS 206, are within the scope of the present invention. Further, although only two service providers 210, 212 and three customer premises 202 are shown in FIGS. 2-3, the systems 200, 250 disclosed herein are not so limited, and can support other numbers of subscriber units and service providers.

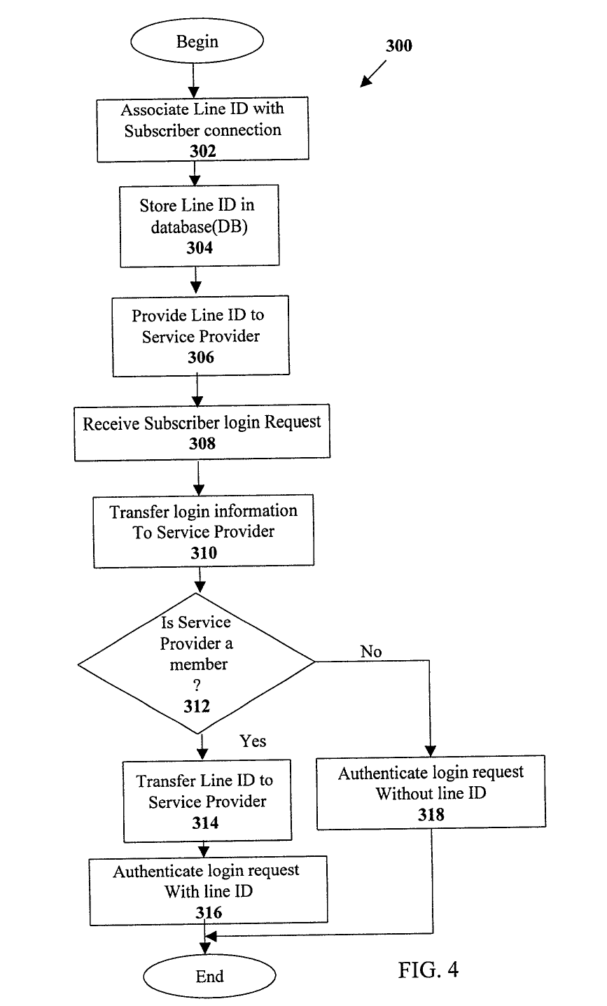

FIG. 4 is a flow chart 300 illustrating the operation of the systems 200, 250 shown in FIGS. 2-3. In step 302, a line ID is associated with a subscriber connection. The association of a line ID with a logical or physical port on a B-RAS 206 can be accomplished though the management interface 230 at the time of provisioning initial service to a subscriber unit, as discussed above.

The line ID is then stored in the subscriber database 240 (step 304) using the database interface 232. The database interface 232 can include a software program and suitable hardware for accessing information stored in the databases 238, 240.

When a customer subscribes to a service provided by one of service providers 210, 212, the service provider can then ask the subscriber for the line ID assigned to them by the carrier 205, 252. Subscribing to a service can also include arranging to access an enterprise network, such as an employer's corporate network, from home.

In step 306, the line ID is provided to one or more of the service providers, prior to the subscriber unit attempting to access the service. Since the line ID is provided to the subscriber when they sign up with the carrier, the line ID can be given to the service providers verbally by the subscriber when the subscriber initially signs up for their service(s).

The stage is now set for the subscriber to login to the service to which he/she has subscribed. The subscriber provides the login ID and password assigned by their service provider, which is transmitted to the B-RAS 206 (step 308). The login request can include user information, such has a user login ID and/or a password. The request can also include a service identifier that identifies the service provider. Various arrangements and protocols can be used to connect the subscriber unit to the B-RAS 206. For example, the subscriber unit can be a computer that uses the Point-to-Point Protocol (PPP) Internet protocol to transmit the subscriber login and password to the B-RAS.

In step 310, the B-RAS 206 transfers the login information, which includes the login ID and password, to the provider. The B-RAS 206 can forward the login ID and password using the RADIUS protocol, which transports authentication information.

In step 312, a check is made to determine whether the service provider corresponding to the service identifier has subscribed to the line ID service. Software in the B-RAS 206 checks to see if the requested service provider is a subscriber to the line ID service by querying the SP DB 238. If the service provider is a subscribing member, the B-RAS 206 transfers the line ID corresponding to the subscriber request to the service provider (step 314). To accomplish this, the B-RAS 206 retrieves the line ID from the database 240 assigned to the subscriber line or port and then sends it to the selected service provider over the broadband network 208. The delivery of the line ID can be done by including it with other authentication information, such as the login ID and password of the subscriber. This can be done by using the RADIUS standard for exchanging authentication information. The RADIUS protocol can be extended to accommodate this additional information by defining a new protocol information element for transferring the line ID.

If the service provider is not a subscribing member, then the service provider can authenticate the request using only the login ID and password, without the line ID (step 318).

In step 316, the service provider authenticates the login request, relying on the line ID. The service provider can make sure the subscriber has a valid login ID and password, and it can also check to see if the line ID matches up with that supplied previously. If it does not, the service provider can deny access, or attempt some other form of authentication, such as sending a sequence of requests for additional information to the subscriber by way of the B-RAS 206 and then verifying this additional information against additional subscriber information stored in either the subscriber database 240 or service provider databases 216, 220.

According to one embodiment of the invention, the service provider's RADIUS server can match all three pieces of data—the login ID, password, and line ID—against its database of user information. The authentication can be based on the line, user ID and password. The RADIUS server 214, 218 stores a database 216, 220 of line IDs, login IDs and passwords that is maintained by the service provider. The RADIUS server can verify the line and login ID and password sent in the request from the B-RAS against the subscriber information in the database. If it matches, the RADIUS server acknowledges back to the B-RAS that the information is valid and the connection can be established. Otherwise, the RADIUS server indicates an authentication failure back to the B-RAS, and the connection between the subscriber and the service provider is not allowed.

In an alternative embodiment of the invention, the B-RAS 206 first sends the login ID and password to the selected service provider. The service provider then checks this information against its user information database. If the login ID and password match an entry in the database, the service provider queries the B-RAS 206 for the line ID. In response to this query, the B-RAS 206 retrieves a corresponding line ID for its database 240 and then transfers it to the service provider. The service provider then verifies the line ID. If it is a valid line ID, the service provide signals the B-RAS 206 to establish a connection between the requesting subscriber unit and the service provider. Otherwise, the service provider signals the B-RAS 206 to deny the connection, or to initiate a procedure for attempting another form of authenticating the request, such as the one described above.

In a further embodiment, the B-RAS 206 can perform the authentication of the subscriber login for the service provider based on the login and line ID and password. In this arrangement, the B-RAS 206 includes a software program for comparing the login ID, line ID and password against the same entries stored in the subscriber database 206. After performing the check, the B-RAS 206 sends the subscribing service provider a message indicating either a successful or failed authentication, and if the authentication is successful, the B-RAS 206 establishes a connection to the service provider.

Another application of the line ID service is in the general area of collecting customer information. Additional subscriber information, such as mailing addresses, geographic identifier, phone numbers, subscriber demographics, and the like can be associated with line ID and stored in the subscriber database 240. This information can be provided to service providers, and can also be used by software programs executing on the B-RAS 206 that provide back-up subscriber authentication routines, should the line ID authentication fail, as discussed above.

While specific embodiments of the present invention have been shown and described, it will be apparent to those skilled in the art that the disclosed invention may be modified in numerous ways and may assume many embodiments other than those specifically set out and described above. Accordingly, the scope of the invention is indicated in the appended claims, and all changes that come within the meaning and range of equivalents are intended to be embraced therein.

1. A method for providing a line identifier to a service provider, comprising:
associating the line identifier with a port assigned to a subscriber, the line identifier being usable to authenticate a service request;
storing the line identifier in a database;
receiving the service request from the subscriber on the port;
retrieving the line identifier from the database in response to the service request; and
transferring the line identifier to the service provider.

2. The method of claim 1, further comprising:
authenticating a subscriber identifier obtained from the service request; and
querying the database in response to the authenticated subscriber identifier to retrieve the line identifier therefrom.

3. The method of claim 2, further comprising:
authenticating the subscriber identifier at the service provider.

4. A method of authenticating a subscriber request for a service, comprising:
receiving the subscriber request on a port of a remote server;
transferring a subscriber identifier obtained from the subscriber request to a provider of the service;
transferring to the provider a line identifier corresponding to the port; and
authenticating the service request based on the subscriber identifier and the line identifier.

5. The method of claim 4, further comprising:
authenticating the subscriber identifier; and
querying a database in response to the authenticated subscriber identifier to retrieve the line identifier therefrom.

6. The method of claim 4, wherein the subscriber identifier and the line identifier are transferred together to the provider.

7. The method of claim 4, wherein the subscriber identifier in the line identifier are transferred separately to the provider.

8. The method of claim 4, wherein the service request is authenticated by the provider.

9. A system for providing a line identifier to a service provider, comprising:
means for associating the line identifier with a port assigned to a subscriber, the line identifier being usable to authenticate a service request;
means for storing the line identifier in a database;
means for receiving the service request from the subscriber on the port;
means for retrieving the line identifier from the database in response to the service request; and
means for transferring the line identifier to the service provider.

10. The system of claim 9, further comprising:
means for authenticating a subscriber identifier obtained from the service request; and
means for querying the database in response to the authenticated subscriber identifier to retrieve the line identifier therefrom.

11. The system of claim 9, further comprising:
means for authenticating the subscriber identifier at the service provider.

12. A remote access server, comprising:
a port for communicating with a subscriber;
a management interface for associating a line identifier with the port;
a database, operatively associated with the management interface, for storing the line identifier;
a database interface for retrieving the line identifier in response to receiving a subscriber service request on the port; and
a network interface for transferring the retrieved line identifier to a service provider.

13. The remote access server of claim 12, wherein the database interface queries the database in response to an authenticated subscriber identifier to retrieve the line identifier from the database.

14. The remote access server of claim 12, wherein the network interface transfers a subscriber identifier to the service provider.

15. The remote access server of claim 14, wherein the subscriber identifier and the line identifier are transferred together to the service provider.

16. The remote access server of claim 14, wherein the subscriber identifier and the line identifier are transferred separately to the service provider.

17. A system for accessing a network service, comprising:
a provider of the network service;
a subscriber unit configured to present a user interface for selecting the network service;
an access server including a port for communicating with the subscriber unit and for associating a line identifier with the subscriber unit;
a database, operatively associated with the access server, for storing the line identifier;
a database interface for retrieving the line identifier in response to receiving a request for the network service on the port; and
a network for transferring the retrieved line identifier to the provider;
wherein the provider authorizes access to the service based on the retrieved line identifier.

18. The system of claim 17, wherein the network transfers a subscriber identifier to the provider and the provider authorizes access to the service based on subscriber identifier and the retrieved line identifier.

19. The system of claim 18, wherein the subscriber identifier and the line identifier are transferred together to the provider.

20. The system of claim 18, wherein the subscriber identifier and the line identifier are transferred separately to the provider.

21. A computer-usable medium storing a computer program for directing a programmable device to perform a method comprising:
associating the line identifier with a port assigned to a subscriber, the line identifier being usable to authenticate a service request;
storing the line identifier in a database;
receiving the service request from the subscriber on the port;
retrieving the line identifier from the database in response to the service request; and
transferring the line identifier to the service provider.

22. A system for providing access to a network service, comprising:
a service provider for providing the network service;
a subscriber unit having a user interface for selecting the network service;
a remote access server including a port for communicating with the subscriber unit and a management interface for associating a line identifier with the subscriber unit;
a broadband network connecting the subscriber unit and the remote access server;
a database, operatively associated with the access server, for storing the line identifier;
a database interface for retrieving the line identifier in response to receiving a subscriber request for the network service on the port; and
a network for transferring to the service provider the retrieved line identifier and a subscriber identifier obtained from the subscriber request;
wherein the service provider authorizes access to the network service based on the retrieved line identifier and the subscriber identifier.
